(19) United States
(12) Patent Application Publication
(10) Pub. No.: US 2011/0145997 A1
(43) Pub. Date: Jun. 23, 2011

(54) FOLDABLE TOOL KIT FOR POSITIONING THE TOOL

(76) Inventor: Shu Te WU, Wu Feng (TW)

(21) Appl. No.: 12/972,446

(22) Filed: Dec. 18, 2010

(30) Foreign Application Priority Data
Dec. 22, 2009 (TW) 098144269

(51) Int. Cl. B25F 1/04

(52) U.S. Cl. 7/118

(57) ABSTRACT

A foldable tool kit for positioning the tool, comprising a case, a plurality of tools and a plurality of orientation rings. The case includes two lateral sideboards and at least one pivot shaft interconnected the two sideboards. The tools pivotally connected to the pivot shaft to rotate thereabout; a lateral face of a pivot end of each tool is formed with at least one retaining portion. At least one lateral face of each orientation ring has at least one engaging portion. The orientation rings sleeves on the pivot shaft but fails to rotate, and are arranged among the tools. The retaining portion of each tool mates with the engaging portion of the adjacent orientation ring so as to block the relative movement between the tool and the orientation ring, whereby the tool is capable of positioning while in use.

### FIELD OF THE INVENTION

The present invention relates to a hand tool, and more particular to a foldable tool kit, which facilitates the positing of the tool while in use.

### BACKGROUND OF THE INVENTION

The conventional foldable tool kit includes a case and a plurality of tools rotationally attached within the case. It's convenient to implement the outward rotation of any tool to drive the nuts or screws; after use, the respective tool is collected toward the case for suitable portability.

However, there is no position design in the conventional foldable tool kit. The in-use tool with poor positioning function is disadvantaged of coming adrift affects the implementation thereof.

### SUMMARY OF THE INVENTION

It is therefore a primary object of the present invention to provide a foldable tool kit, which is capable of positioning a tool at a specific angular position after rotation.

To achieve the above and other objects, a foldable tool kit for positioning the tool in accordance with the present invention includes a case, which has two lateral sideboards paralleled to each other. At least one pivot shaft is arranged between the two sideboards. Plural of tools are pivotally connect to the pivot shaft between two sideboards via a pivot end thereof so as to meet the turn-free rotation. Each tool has at least one retaining portion formed on a lateral face of the pivot end thereof. Plural of orientation rings, each orientation rings has at least one engaging portion formed on at least one lateral face thereof; the orientation rings are disposed on the pivot shaft and arranged among the tools but fails to rotate on the pivot shaft.

Therefore, the retaining portion of the tool mates with the engaging portion of the orientation ring while the tool in use and the tools are provided with a positing point of rotation.

Preferably, each orientation ring is formed with a sleeve hole in order to sleeve onto the pivot shaft. An exterior perimeter of the pivot shaft and the sleeve hole of each orientation ring are non-circular shaped, and it enables the orientation rings engage with the pivot shaft.

The present invention can be best understood through the following description and accompanying drawings wherein:

### BRIEF DESCRIPTION OF THE DRAWINGS

FIG. 1 is a perspective view of a first embodiment of the present invention;

FIG. 2 is a decomposition view of FIG. 1;

FIG. 3 is a cross-sectional profile along line 3-3 of FIG. 1;

FIG. 4 is a cross-sectional profile of an orientation ring of the first embodiment of the present invention;

FIG. 5 is a cross-sectional profile along line 5-5 of FIG. 3;

FIG. 6 is a cross-sectional profile along line 6-6 of FIG. 3;

FIG. 7 is a perspective view showing the tools outwardly stretching according to the present invention;

FIG. 8 is a decomposition view of a second embodiment of the present invention;

FIG. 9 is a cross-sectional profile of FIG. 8;

FIG. 10 is a decomposition view of a third embodiment of the present invention;

FIG. 11 is a cross-sectional profile of an orientation ring of FIG. 10;

FIG. 12 is a perspective view of a fourth embodiment of the present invention;

FIG. 13 is a decomposition view of FIG. 12;

FIG. 14 is a cross-sectional profile along line 14-14 of FIG. 12;

FIG. 15 is a perspective view of a fifth embodiment of the present invention;

FIG. 16 is a decomposition view of FIG. 15;

FIG. 17 is a perspective view of a tool corresponding to the fifth embodiment of the present invention; and

FIG. 18 is a cross-sectional profile along line 18-18 of FIG. 15.

### DETAILED DESCRIPTION OF THE PREFERRED EMBODIMENTS

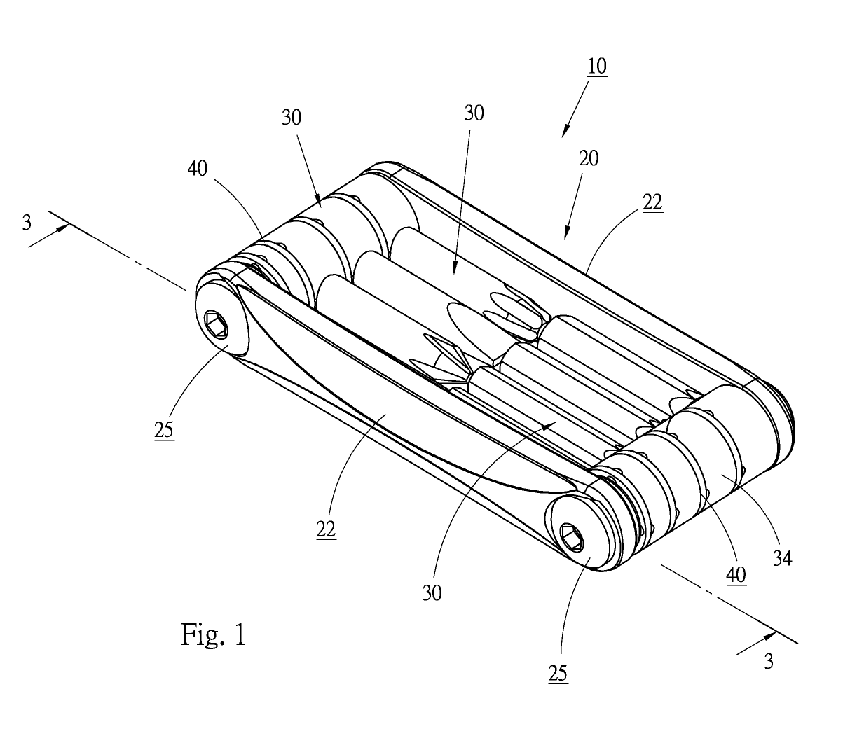

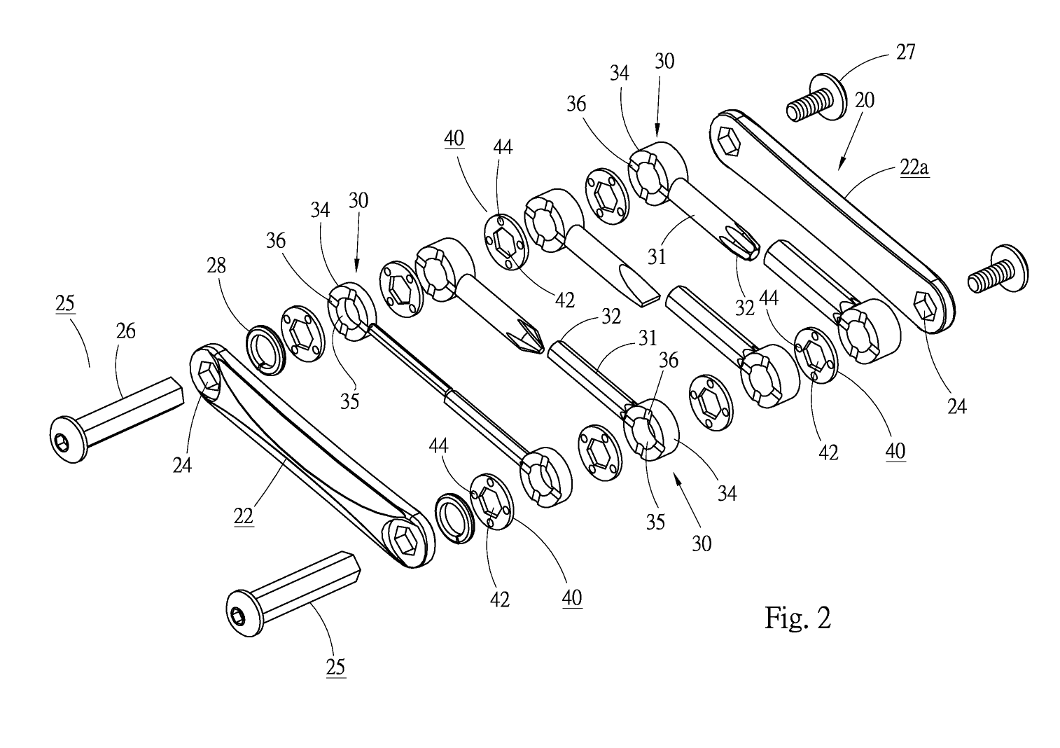

Please refer to FIGS. 1 and 2, the foldable tool kit 10 for positioning the tool of a first embodiment in accordance with the present invention includes a case 20, a plurality of tools 30 pivotally connected to an end or two ends of the case 20, and a plurality of orientation rings 40. In this embodiment, two ends of the case 20 are pivotally connected with several tools 30.

The case 20 could be configured of any shape and type, and at least include two sideboards 22 parallel to and distanced from each other. Two ends of each sideboard 22 is formed with a non-circular connection hole 24, such as hexagonal, tetragon, polygon, specific forms or the likes, but not restrained.

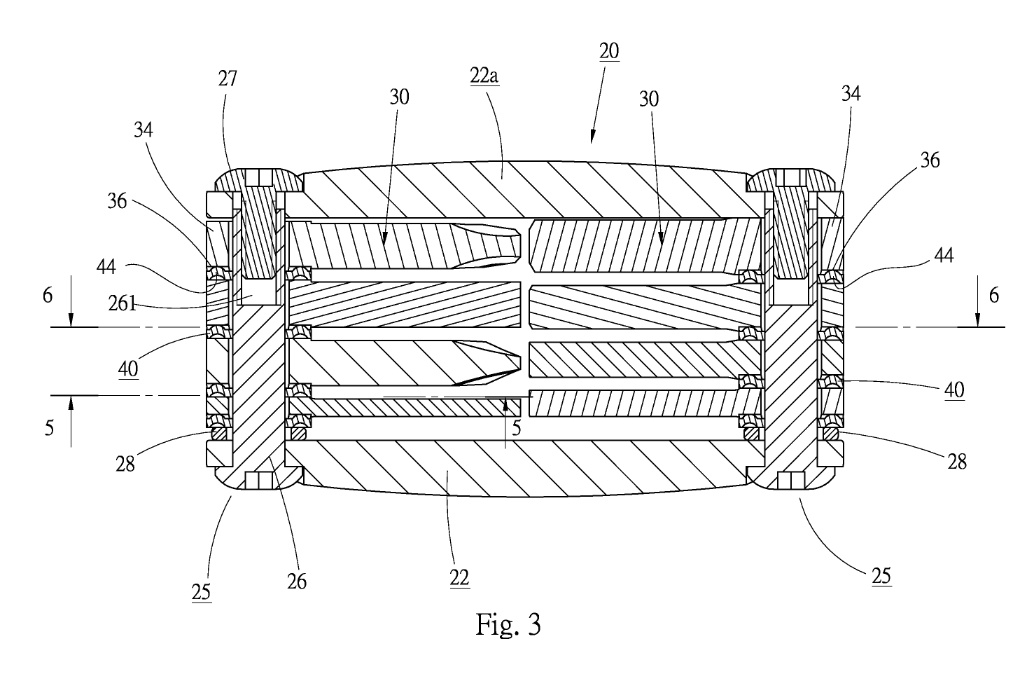

With respect to FIG. 3, two pivot shafts 25 are provided, and each includes a screw rod 26 with an inner screw hole 261, and a screw member, such as a screw 27. An exterior perimeter of each pivot shaft 25 (, the screw rod,) is of non-circular configuration in order to correspond to the shape of the connection hole 24 of the sideboard 22. By fastening the screw rod 26 to the screw 27, the two pivot shafts 25 dispose at the connection holes 24 of the two sideboards 22, as illustrated in FIG. 3, a head of the screw rod 26 abuts against one sideboard while the screw 27 abuts against the other one. The exterior perimeter of each pivot shaft 25 engages with the hole wall of each connection hole 24 to block the pivot shaft 25 from rotation.

Each tool 30 is rod-liked. An end of a rod body 31 of each tool 30 is defined as an operation end 32, and the other end is defined as a pivot end 34 formed with a pivot hole 35. The operation ends 32 of the tools 30 are shaped with various sizes and configurations, such as bits of hexagonal, crisscross, chisel or polygon forms, for meeting different screw members. The operation end 32 is not limited to bits but also other parts, such as a polygon sleeve hole for the screw nuts. The pivot end 32 of each tool 30 is annular and formed with quantity-predetermined, such as four, retaining portions 36 at a lateral face thereof. The retaining portions 36 are arranged in a circle order and spaced at a right angle, and to be in concentricity with the pivot hole 35. The pivot ends 34 of the tools 30 respectively sleeve onto the pivot shaft 25 between the two sideboards 25, and the tools are of turn-free rotation on the pivot shaft.

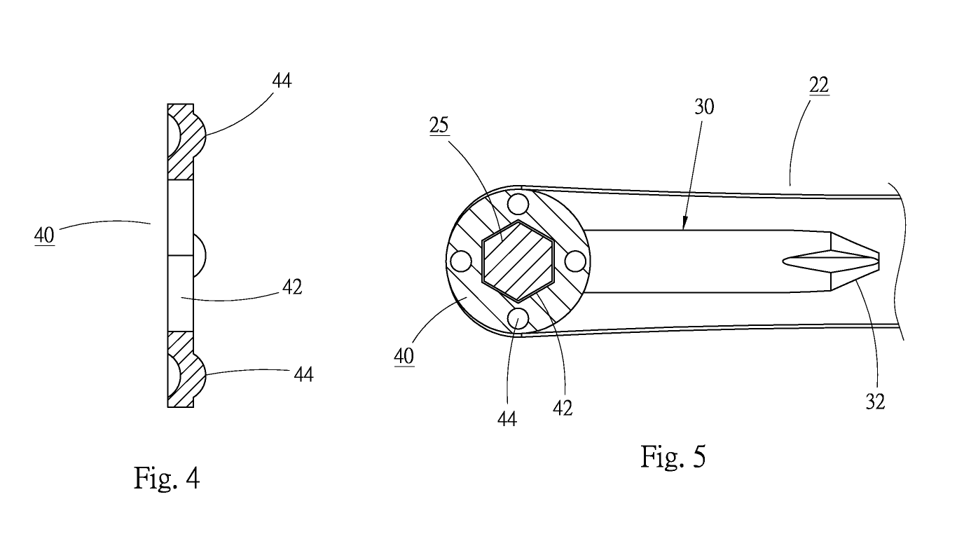

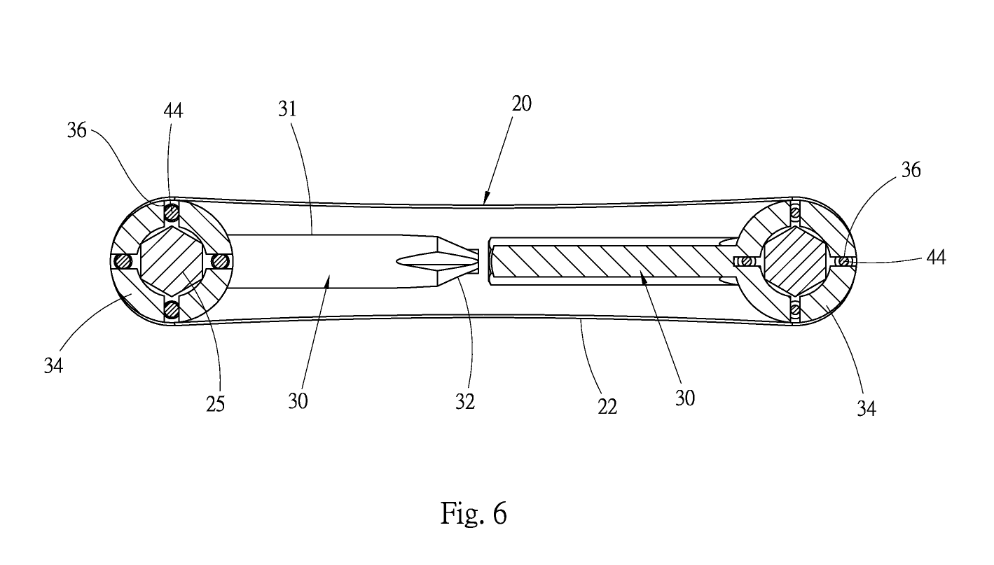

A central of each orientation ring 40 is formed with a non-circular sleeve hole 42, such as hexagonal or tetragon forms, in order to correspond to the exterior perimeter of the pivot shaft 25. Each orientation ring 40 has a plurality of engaging portions 44 at a lateral face thereof, as in FIG. 4. The engaging portions 44 are in concentricity with the sleeve hole 42. The orientation rings 40 are respectively sleeved onto the pivot shaft 25, and the orientation rings are arranged with the tools 30 in a staggered order. The hole wall of the sleeve hole 42 fits to engage with the exterior perimeter of the pivot shaft 25, as illustrated in FIG. 5, the orientation ring 40 thereby are blocked from rotating about the pivot shaft 25. In the embodiment, the quantity of the orientation rings 40 are as same as that of the tools 40, and the engaging portions 44 of each orientation ring 40 match the retaining portions 36 of the respective tool 30. Referring to FIG. 3, the engaging portions 44 and the retaining portions 36 are convex-concave designed. The engaging portions 44 are convex while the retaining portions 36 are concave, vice versa. Therefore, the retaining portions 36 and the engaging portions 44 mate with each other for engagement, as in FIG. 6. It's reasonable that the quantity of the retaining portions 36 of each tool 30 is no need to be the same as that of the engaging portions 44 of each orientation ring 40.

Because the orientation ring 40 is unable to rotate, the tools 40 could be positioned at specific angular positions when the retaining portion 36 mates with the engaging portion 44.

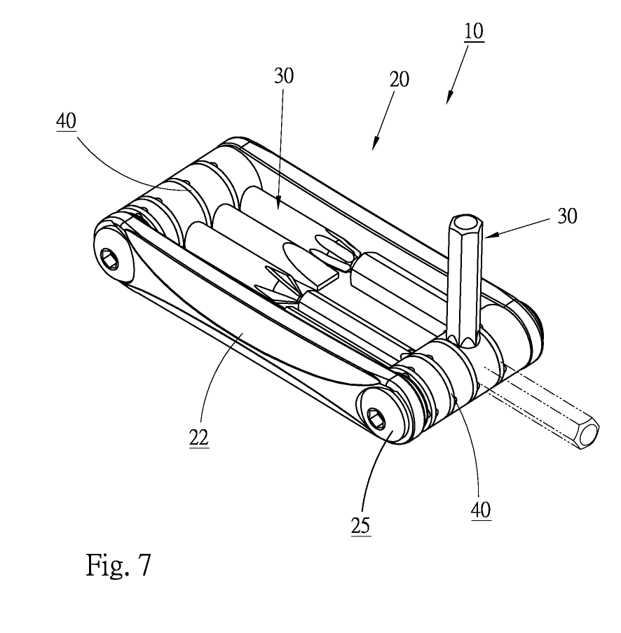

With respect to FIG. 7, the tools are able to be folded and collected into the case 20, stretched outwards raging a right angle as shown by the solid line, or stretched outwards raging a straight angle as shown by the imagination line. The retaining portion 36 mates with the engaging portion 44 so as to posit the respective tool 30. Therefore, the tool is posited at specific/different angular positions while folding or stretching, and it's convenient for users. When the retaining portion 36 departs from the engaging portion 44 while the tool 40 rotates to get away from the positing position, a push resilient resistance between the tool 30 and the corresponding orientation ring 40 is created. When the retaining portion 36 fit to mate with the engaging portion 44 while the tool 40 rotates to meet the positing position, a steady positing between the tool 30 and the corresponding orientation ring 40 is created, and for user, the resilient positing implementation is offered thereby.

In addition, each pivot shaft 25 could be further applied with a resilient member, such as a resilient washer 28, to enable the tools 30 keep flexible contact with the orientation rings 30. Nevertheless, the resilient washer 28 is not necessary but the elastics it provides could be substituted by sideboards, which is of flexibility.

There are more than two tools 30 are provided to each end of the case 20 according to the present invention. By the mating design due to the incapability of rotation of the orientation ring 40, the tool is able to position while rotating. According to the design of the invention, the position function for each single tool is provided; no matter how many tools are set.

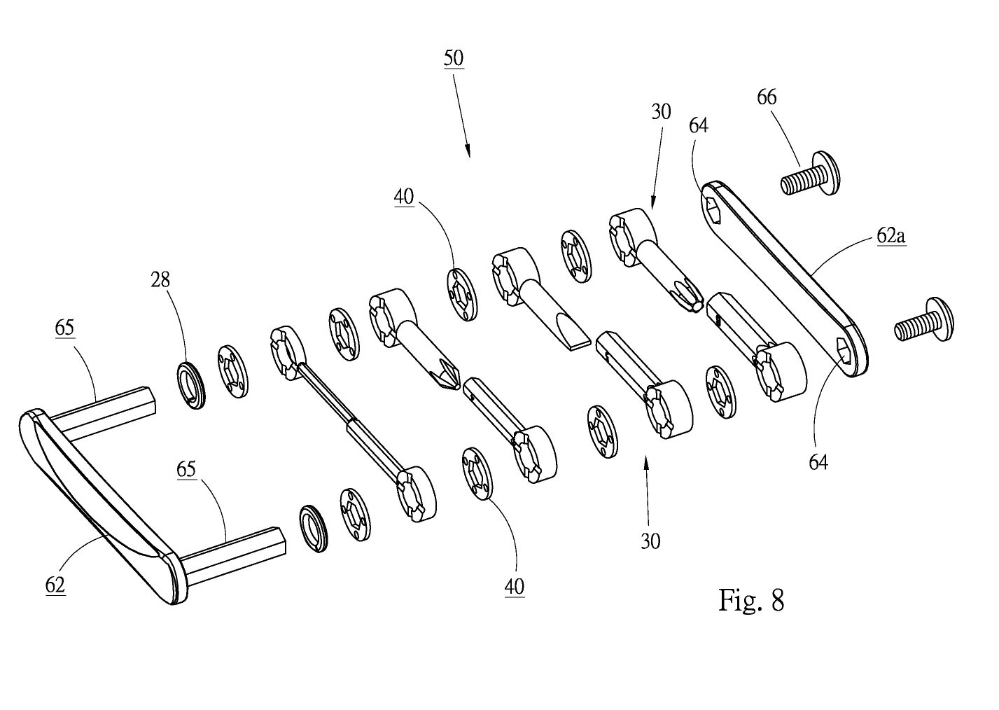

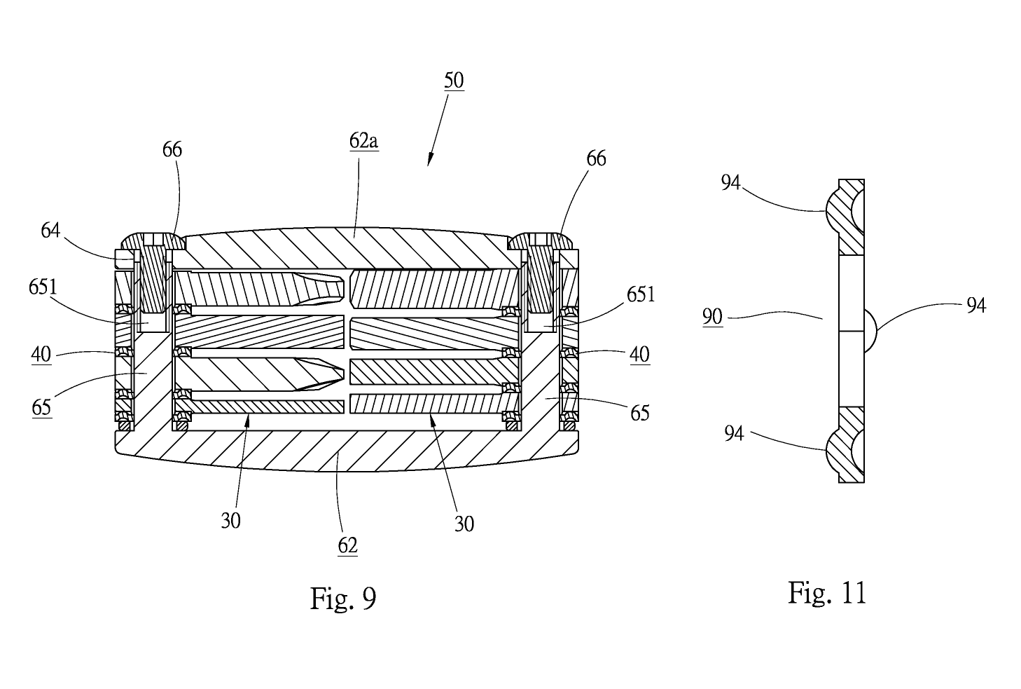

Referring to FIGS. 8 and 9, a foldable tool kit 50 of a second embodiment according to the present invention is disclosed. The tools 30 and the orientation rings 40 are as same as those in the first embodiment and continue to use their numerals.

In the embodiment, an end of each pivot shaft 65 connects to a lateral face of a first sideboard 62. Two ends of a second sideboard 62a are respectively formed with a connection hole 64. A screw 66 is applied to screw to an inner screw hole 651 of a free end of each pivot shaft 65; to attach the free end of each pivot shaft 65 to the second sideboard 62a; and to assembly the sideboard and the pivot shaft to accomplish the embodiment. The tools 30 and the orientation rings 40 are similarly arranged to the two pivot shafts 65 so that the tools 30 are able to be positioned after rotation. Each connection hole 64 of the second sideboard 62a could be non-circular or circular shaped. Similarly, the connection hole 24 of a second sideboard 22a in the first embodiment is also non-circular or circular shaped.

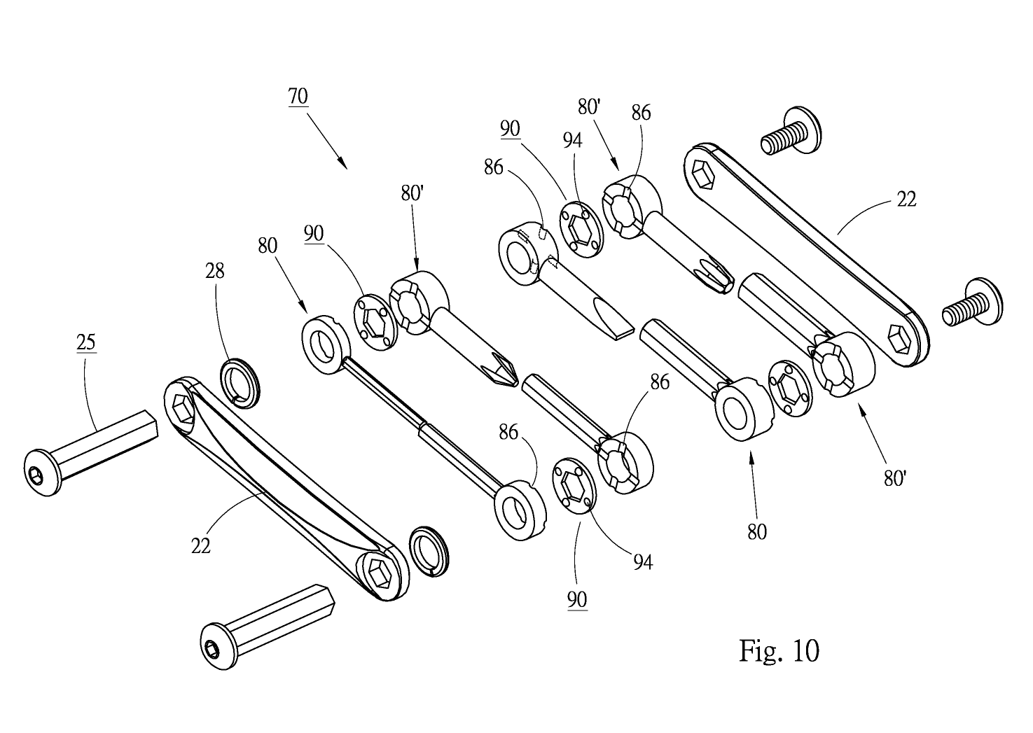

In the mentioned embodiments, the retaining portions of each tool are formed at the same lateral face, which means the retaining portions are set towards the same direction. Please refer to FIG. 10, a foldable tool kit 70 of a third embodiment according to the present invention is disclosed. Except the previous ones, the arrangement between the tools and the orientation rings could be implemented corresponding to this embodiment. There is one or two orientation rings 90 placed between two tools 80, 80′, which is in pair. The retaining portions 86 of the paired tools 80, 80′ face to each other; the engaging portions 94 of the orientation ring or rings 90, that is/are positioned between the two tools 80, 80′, mate with the retaining portions of the paired tools.

If only one orientation ring 90 is applied between the two tools 80, 80′, the two tools 80, 80′ are sharing the same orientation ring 90, as illustrated in FIG. 11. Meanwhile, two lateral faces of the orientation ring 90 are arranged with the engaging portions 94 for mating the retaining portions 86 of the two tools 80, 80′. In the same manner, the engaging portions 94 are concave or convex.

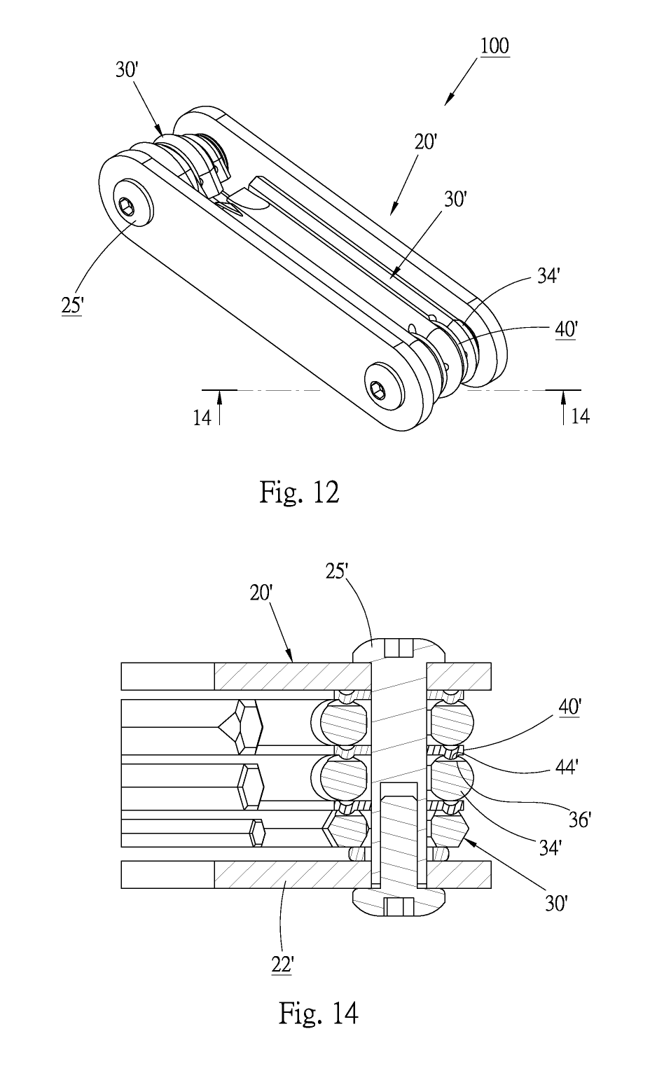

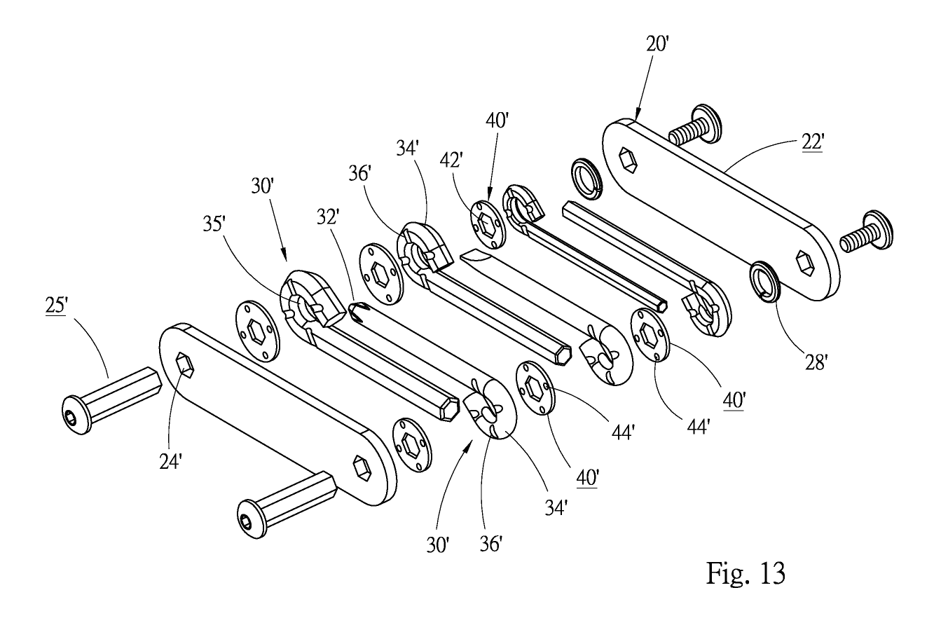

With respect to FIGS. 12 to 14, a foldable kit 100 of a fourth embodiment according to the present invention is disclosed, in which the designated numerals are continued. The foldable kit 100 includes a case 20′, a plurality of tools 30′, and plurality of orientation rings 40′. Each tool 30 are pivotally connected to a pivot shaft 25′ of the case 20′ via an annular pivot end 34′ thereof; the retaining portions 36′ of each tool 30′ mate with the engaging portions 44′ of each orientation ring 40′ in order to position the tool.

The structure of this embodiment is substantially similarly to the tool kit 10 of the first embodiment; the difference is the configurations of the tools 30′ slightly differ from those of the tools 30.

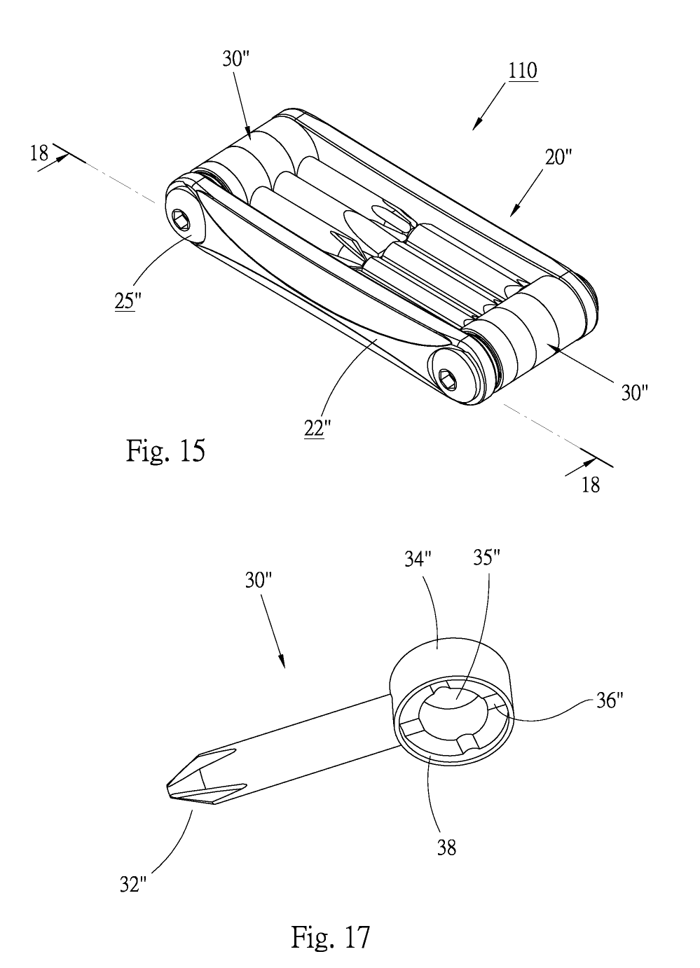

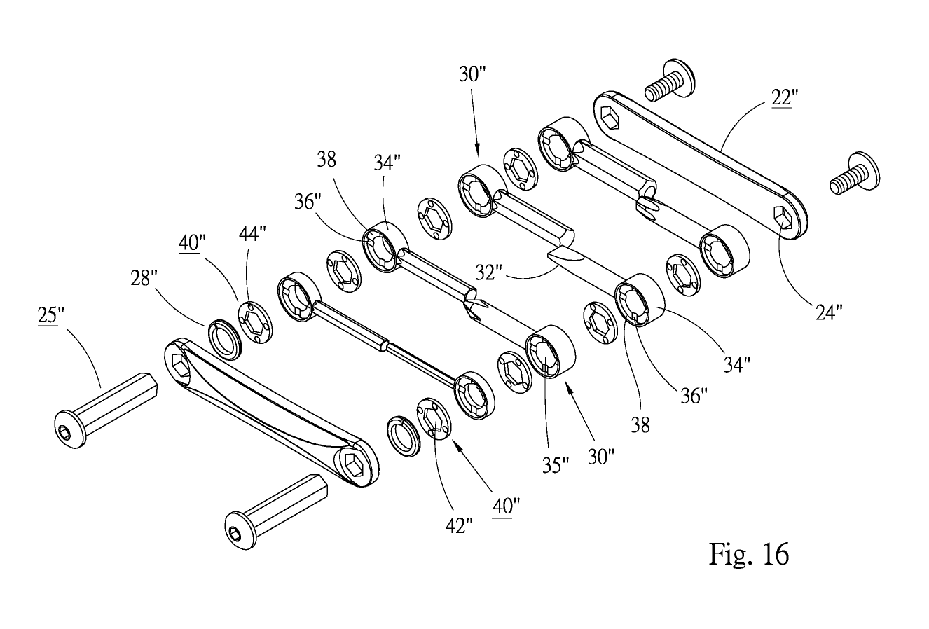

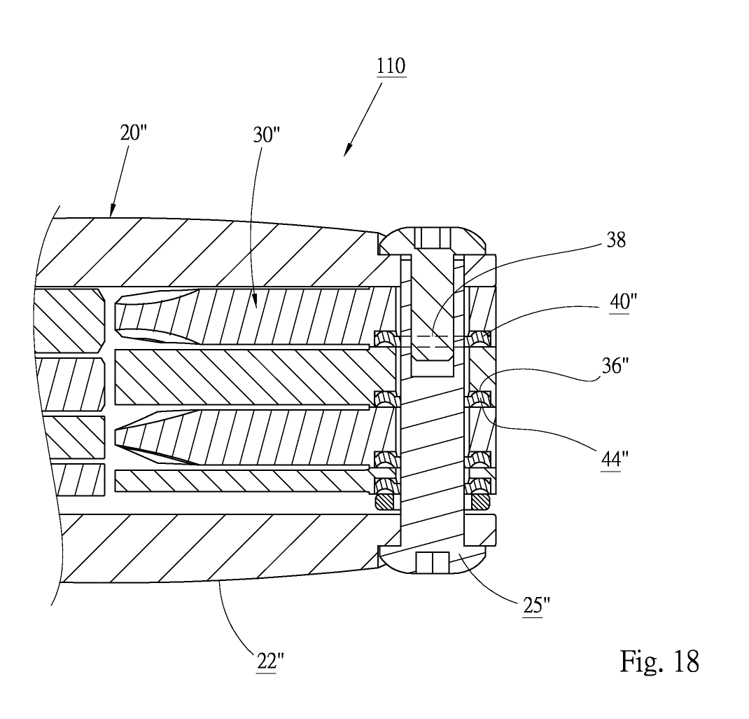

With respect to FIGS. 15 to 18, a foldable kit 110 of a fifth embodiment according to the present invention is disclosed, in which the designated numerals are continued.

The difference in this embodiment is a lateral side of the pivot end 34″ of the tools 30″ is further formed with a recess 38, and the retaining portions 36″ are located inside the recess 38.

Each orientation ring 40″ is received in the recess 38 of each tool 30″. The engaging portion 44″ mate with the retaining portions 36″ of the tool 30″. In this embodiment, the orientation rings 40″ are hidden in the pivot end of each tool 30″ and will not be exposed.

The structures of the fourth and fifth embodiments can be applied to the second and third embodiments.

The foldable tool kit according to the present invention is thereby capable of positioning the tool at a specific angular position while in use. And the angular position of the tool is not limited to the illustration of the invention.

The above embodiments are only used to illustrate the present invention, not intended to limit the scope thereof. Many modifications of the above embodiments can be made without departing from the spirit of the present invention.

What is claimed is:

1. A foldable tool kit for positioning the tool, comprising:
a case including two lateral sideboards paralleled to each other;
at least one pivot shaft interconnected to an end of each lateral sideboard; the pivot shaft is blocked to rotate with the two lateral sideboards;
a plurality of tools, and an end of each tool being a pivot end with a pivot hole while an opposite end being an operation end; the pivot end of the tools being pivotally connected to the pivot shaft via the pivot hole so as to enable the tools rotate about the pivot shaft; a lateral face of the pivot end of each tool being formed with at least one retaining portion; and
a plurality of orientation rings formed with a sleeve hole; at least one lateral face of each orientation ring having at least one engaging portion; the orientation rings being sleeved on the pivot shaft via the sleeve hole and located among the tools; the sleeve hole of each orientation ring engaging with an exterior perimeter of the pivot shaft to block the orientation ring from rotating about the pivot shaft; the retaining portion of each tool being mated with the engaging portion of the adjacent orientation ring to engage the relative movement therebetween, whereby the tool is capable of positioning while in use.

2. The foldable tool kit as claimed in claim 1, wherein each tool has a rod body; the pivot end is annular and disposed at an end of the rod body, and an interior of the pivoted end is formed with the pivot hole; the operation end is disposed at the other end of the rod body.

3. The foldable tool kit as claimed in claim 1, wherein the pivot end of each tool is arranged with plural of the retaining portions, and the retaining portions are formed in concentricity with the pivot hole; at least one lateral face of each orientation ring includes plural of the engaging portions, and the engaging portions are formed in concentricity with the sleeve hole.

4. The foldable tool kit as claimed in claim 1, wherein the retaining portions are formed at the same lateral side of each tool; the orientation rings are arranged with the tools in a staggered order.

5. The foldable tool kit as claimed in claim 1, wherein at least two tools are arranged in pair; the retaining portions of the pair face to each other; at least one orientation ring are placed between the pair.

6. The foldable tool kit as claimed in claim 5, wherein one orientation ring is disposed between the paired tools, and two lateral faces of the orientation ring are formed with at least one engaging portion.

7. The foldable tool kit as claimed in claim 1, wherein the pivot end of each tool has a recess formed on at least one lateral face thereof; the retaining portion is arranged in the recess; each orientation ring is received in the recess.

8. The foldable tool kit as claimed in claim 3, wherein the pivot end of each tool has a recess formed on at least one lateral face thereof; the retaining portion is arranged in the recess; each orientation ring is received in the recess.

9. The foldable tool kit as claimed in claim 1, further including at least one resilient member disposed on the pivot shaft, which is of elastics enabling the tools keep flexible contact with the orientation rings.

10. The foldable tool kit as claimed in claim 7, further including at least one resilient member disposed on the pivot shaft, which is of elastics enabling the tools keep flexible contact with the orientation rings.

11. The foldable tool kit as claimed in claim 1, wherein each sideboard includes a connection hole formed at least one end thereof; the pivot shaft includes a screw rod and a screw member fastened to each other; two ends of the screw rod respectively penetrate the connection holes of the two sideboards; an exterior perimeter of the screw rod engages with hole wall of the two connection holes to block the screw rod from rotation.

12. The foldable tool kit as claimed in claim 7, wherein each sideboard includes a connection hole formed at least one end thereof; the pivot shaft includes a screw rod and a screw member fastened to each other; two ends of the screw rod respectively penetrate the connection holes of the two sideboards; an exterior perimeter of the screw rod engages with hole wall of the two connection holes to block the screw rod from rotation.

13. The foldable tool kit as claimed in claim 1, wherein the two sideboards are respectively defined as a first sideboard and a second sideboard; at least one end of the first sideboard is formed with a connection hole; at least one end of the second sideboard is also formed with a connection hole; the pivot shaft includes a screw rod and a screw member fastened to each other; an end of the screw rod engages the connection hole of the first sideboard while an exterior perimeter of the screw rod engages with a hole wall of the connection hole of the first sideboard so as to block the screw rod form rotation; the other end of the screw rod connects with the connection hole of the second sideboard by screwing to the screw member.

14. The foldable tool kit as claimed in claim 1, wherein the two sideboards are respectively defined as a first sideboard and a second sideboard; an end of the pivot shaft is fixed to an end of the first sideboard, while a free end of the pivot shaft connects to an end of the second sideboard via a screw member.

15. The foldable tool kit as claimed in claim 14, wherein the second sideboard has a connection hole formed on at least one end thereof; the free end of the pivot shaft penetrates the connection hole; the screw member screws to a free end of the pivot shaft.

16. The foldable tool kit as claimed in claim 15, wherein the connection hole of the second sideboard engages with the exterior perimeter of the pivot shaft.

17. The foldable tool kit as claimed in claim 1, wherein the retaining portions are concave while the engaging portions are convex; or the retaining portions are convex while the engaging portions are concave.

18. The foldable tool kit as claimed in claim 1, wherein an exterior perimeter of the pivot shaft and the sleeve hole of each orientation ring are non-circular shaped.

19. The foldable tool kit as claimed in claim 11, wherein the connection hole of each the sideboard and an exterior perimeter of the screw rod are non-circular shaped.

20. The foldable tool kit as claimed in claim 7, wherein the two sideboards are respectively defined as a first sideboard and a second sideboard; an end of the pivot shaft is fixed to an end of the first sideboard, while a free end of the pivot shaft connects to an end of the second sideboard via a screw member.
